(19) United States
(12) Patent Application Publication
(10) Pub. No.: US 2023/0182030 A1
(43) Pub. Date: Jun. 15, 2023

(54) GAME CARTRIDGE ADAPTER TO ENABLE ONLINE PLAY

(71) Applicant: WATERMELON CO., Muscatine, IA (US)

(72) Inventor: Gwénaël Godde, Muscatine, IA (US)

(21) Appl. No.: 18/063,800

(22) Filed: Dec. 9, 2022

Related U.S. Application Data
(60) Provisional application No. 63/289,271, filed on Dec. 14, 2021.

(51) Int. Cl. A63F 13/98; H02J 7/00

(52) U.S. Cl. CPC A63F 13/98; H02J 7/0034; H02J 7/0047; H01R 24/58

(57) ABSTRACT

A video game cartridge adapter is configured to enable a network connection so that a game executing on video game cartridge can be used online either locally or through the Internet or other wide area network. The adapter includes an integrated circuit with a communications device and a connector, the connector configured to be inserted into a port on a video game cartridge. The connector includes an RX ring in communication with a resistor, which is detected by a pull-down detection circuit at the video game cartridge. The adapter can include an external power supply port, an indicator light, and a reset button. The adapter can also include a current limiter circuit and a reverse voltage protection circuit.

### CROSS REFERENCE TO RELATED APPLICATIONS

N/A

### TECHNICAL FIELD

The present invention generally relates video game technology and more particularly to an adapter to enable online functionality and play of a cartridge-based video game.

### BACKGROUND ART

Although cartridge-based video games eventually gave way to digitally delivered video games, including those made available on optical discs or through digital downloads, there has a been a recent resurgence and interest in cartridge-based video games including those made available for SEGA Genesis/Mega Drive Systems. In some instances, gamers are interested in using their vintage video game systems to play new or “inspired-by” or re-imagined game titles which offer new concepts, gameplay, and strategy, but use vintage gaming hardware. Many vintage game systems do not have online play or other network functionality given that many of these systems were designed before the advent of high-speed internet, or even dial-up internet technology. Accordingly, there is a need to enable online play and other online functionality of games (software updates, online high scores, chat rooms/messaging, online purchases, and the like), intended to be played through vintage video games systems that are not otherwise network or Internet enabled.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

FIG. 1 is a schematic of the system using the adapter.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION OF THE INVENTION

The present invention provides its benefits across a broad spectrum of endeavors. It is applicant’s intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

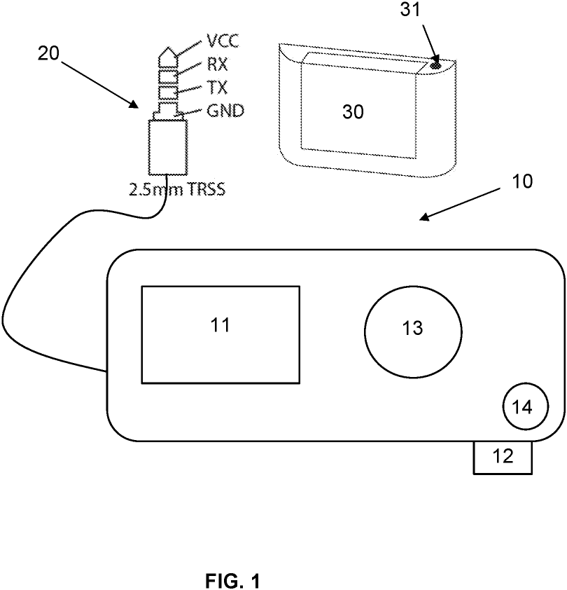

FIG. 1 depicts a schematic of the adapter 10 of the present invention, which includes an integrated circuit 11, an external port 12, a reset button 13, and an indicator light 14. The adapter 10 also includes a connector 20, which in some embodiments comprises a 2.5 mm TRSS connector which is configured to be connected to a game cartridge 30. In some embodiments, the integrated circuit 11 comprises a microprocessor and a communications device, such as a WiFi chipset, Bluetooth radio, or the like, to enable either a direct or an indirect connection to a widearea network (WAN) (e.g., the Internet), or local-area network (LAN). The adapter can also optionally include a voltage limiting circuit to avoid a voltage surge of the game cartridge 30 when an external power supply (discussed below) is not used. The adapter can also include a reverse voltage protection circuit to avoid power irregularities from an improper connection of the connector 20 into an unknown socket. As discussed below, the game cartridge 30 includes a pull-down detection circuit and an external power detection circuit which function with the first and second rings of the connector 20.

In some embodiments, the reset button 13 and indicator light 14 are connected to or are otherwise in communication with the integrated circuit 11 wherein the reset button 13 is enabled to toggle reset of the integrated circuit 11 and the indicator light 14 is configured to display the status of the adapter 10, for example a blue light to indicate power is on, a blinking light to indicate a system notification, or the like. In some embodiments, the external port 12 is configured to be connected to an external power supply such as a USB adapter, smart phone, computer, or AC adapter. The external power supply can be routed through the voltage limiting circuit of the adapter 10 to prevent power surges or other overdraw of current from.

The connector 20 is configured to be inserted into a corresponding port 31 on a game cartridge 30 executing a game thereon, to enable online play or other network functionality of the game through a direct connection to the game cartridge, rather than by connecting to the video game system itself. In some embodiments, the connector 20 comprises a TRSS connector having 4 pins - a tip, a first ring, a second ring, and a sleeve. In some embodiments, the connector 20 is configured with the tip defined as the voltage common collector (VCC), the first ring defined as RX (receive) which is also shared with a pull-down detection circuit at the game cartridge 30, the second ring defined as TX (transmit) also shared with an external power detection circuit at the game cartridge 30 (i.e. to detect the presence of power at the external port 12 supplied through the adapter 10), and the sleeve defined as GROUND.

In some embodiments, the first ring of the connector 20 is in communication with a resistive circuit present on the adapter 10, in the range of, for example, 6-18Kohm, which resistive circuit is detected by the pull-down detection circuit at the game cartridge 30. Detection is accomplished at the game cartridge 30, wherein the game cartridge 30 will determine if the adapter 10 is present by probing the RX state of the adapter 10 at the first ring, via the pull-down detection circuit. In some embodiments, the game cartridge 30 will also probe the TX state of the adapter 10, via the external power detection circuit. If the RX and/or TX states are valid, the game cartridge 30 will enable power to the tip (VCC) of the connector 20 and then the adapter 10 will be enabled and turned on. Accordingly, the adapter 10 is powered by the game cartridge 30 (which, in some embodiments is powered by the gaming system to which the cartridge 30 is attached).

Additionally, in some embodiments, the game cartridge will probe the adapter 10 at the RX ring and wait for the adapter 10 to send via the TX ring a predetermined string of text to the game cartridge 30. The string of text can be used as a secondary enabling requirement for the game cartridge 30 to confirm the presence of the adapter 10. This detection functionality avoids errors or inadvertent triggering of the adapter if it is plugged into the incorrect port, for example an audio or video device that is not compatible with the adapter or if an incorrect device is plugged into the game cartridge 30.

In some embodiments, the invention is a system comprising a video game cartridge 30 defined as a host and the adapter 10 defined as the device. The host includes the pull-down detection circuit and the external power detection circuit. The device includes a connector 20, an integrated circuit 11 with a communications device, a reset button 13, and an indicator light 14. The connector comprises a TRSS connector having a tip defined as a voltage common collector (VCC) fed by the power supply at the host; a first ring defined as RX (receive) at the device, or TX (transmit) by the host, the first ring also used by the detection circuit at the host; a second ring defined as TX (transmit) by the device or RX (receive) by the host, the second ring also used by the external power detection circuit at the host; and a sleeve defined as ground.

Once activated by the game cartridge, the adapter 10 is configured to enable a network connection via the communications device so that the game executing on the cartridge can have “online” or network functionality either locally or through the Internet or other wide area network. It is appreciated and understood that once the game cartridge 30 validates the adapter 10 and turns it on, bi-directional data communication between the cartridge 30 and the adapter 10 occurs over the RX and TX rings of the connector 20 (TX and RX respectively, from the perspective of the game cartridge 30).

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only the claims and equivalents.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this detailed description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A video game cartridge adapter, comprising:
an integrated circuit and a connector;
the connector configured to be attached to a video game cartridge;
wherein the integrated circuit of the adapter enables network functionality of the video game cartridge.

2. The adapter of claim 1, wherein the connector comprises a TRSS connector having a tip defined as a voltage common collector (VCC); a first ring defined as RX and shared with a pull-down detection circuit at the game cartridge; a second ring defined as TX and shared with an external power detection circuit at the game cartridge, and a sleeve defined as ground.

3. The adapter of claim 2, the adapter including a current limiter circuit.

4. The adapter of claim 2, the adapter including a reverse voltage protection circuit.

5. The adapter of claim 1, wherein the adapter is configured to activate upon the game cartridge enabling power to the tip (VCC).

6. The adapter of claim 1, wherein the adapter is configured to send to the game cartridge a predetermined string of text such that the game cartridge can detect the presence of the adapter to confirm the detection of the adapter.

7. A system to enable network functionality of a video game executing on a game cartridge, comprising:
an adapter comprising an integrated circuit and a connector, the connector attached to the video game cartridge;
wherein the connector is configured to be attached to a video game cartridge; and
wherein the integrated circuit of the adapter enables network functionality of the video game cartridge.

8. The system of claim 7, wherein the connector comprises a TRSS connector having a tip defined as a voltage common collector (VCC); a first ring defined as RX shared with a pull-down detection circuit at the game cartridge; a second ring defined as TX shared with an external power detection circuit at the game cartridge; and a sleeve defined as ground.

9. The system of claim 8, the adapter including a current limiter circuit.

10. The system of claim 8, the adapter including a reverse voltage protection circuit.

11. The system of claim 7, wherein the adapter is configured to activate upon the game cartridge enabling power at the tip (VCC).

12. The system of claim 7, wherein the adapter is configured to send to the game cartridge a predetermined string of text such that the game cartridge can detect the presence of the adapter to confirm detection of the adapter.

13. A system to enable network functionality of a video game, comprising:
a video game cartridge defined as a host, the host including a detection circuit and an external power detection circuit;
an adapter defined as a device, the device including a connector, an integrated circuit with a communications device, a reset button, and an indicator light;
wherein the connector comprises a TRSS connector having a tip defined as a voltage common collector (VCC); a first ring defined as RX shared with the pull-down detection circuit at the game cartridge; a second ring defined as TX shared with the external power detection circuit at the game cartridge; and a sleeve defined as ground.
